(19) United States
(12) Patent Application Publication
(10) Pub. No.: US 2024/0029469 A1
(43) Pub. Date: Jan. 25, 2024

(54) ELECTRONIC APPARATUS COMPRISING PIEZOELECTRIC MODULE

(71) Applicant: SAMSUNG ELECTRONICS CO., LTD., Suwon-si (KR)

(72) Inventors: Bongjae RHEE, Suwon-si (KR); Suna KIM, Suwon-si (KR)

(21) Appl. No.: 18/376,401

(22) Filed: Oct. 3, 2023

Related U.S. Application Data
(63) Continuation of application No. PCT/KR22/05932, filed on Apr. 26, 2022.

(30) Foreign Application Priority Data
Apr. 26, 2021 (KR) 10-2021-0053430

(51) Int. Cl. G06V 40/13; H10N 30/05; H10N 30/03; H10N 30/071; H10N 30/88; H10N 30/30; G06F 3/01

(52) U.S. Cl. CPC G06V 40/1306; H10N 30/05; H10N 30/03; H10N 30/071; H10N 30/88; H10N 30/302; G06F 3/016

(57) ABSTRACT

An electronic apparatus according to an embodiment comprises: a housing; and a piezoelectric module including a first region that detects biometric information by using ultrasonic waves and a second region that provides haptic feedback, wherein the piezoelectric module includes: a first electrode layer and a second electrode layer facing each other; and a piezoelectric layer which is positioned between the first electrode layer and the second electrode layer, at least one portion of the piezoelectric layer positioned in the first region of the piezoelectric module may vibrate in a first frequency band to emit the ultrasonic waves, and at least one portion of the piezoelectric layer positioned in the second region of the piezoelectric module may vibrate in a second frequency band lower than the first frequency hand.

### CROSS-REFERENCE TO RELATED APPLICATIONS

This application is a continuation of International Application No. PCT/KR2022/005932, designating the United States, filed on Apr. 26, 2022, in the Korean Intellectual Property Receiving Office and claiming priority to Korean Patent Application No. 10-2021-0053430, filed on Apr. 26, 2021 in the Korean intellectual Property Office, the disclosures of which are incorporated by reference herein in their entireties.

### TECHNICAL FIELD

Various embodiments disclosed herein relate to an electronic device comprising a piezoelectric module.

### BACKGROUND ART

In these days, various types of electronic devices are being developed. For example, mobile devices having various functions, such as smartphones, tablet PCs, or wearable devices, as well as existing desktop PCs, are becoming more and more widespread. In addition, recent electronic devices include various types of sensors to perform various functions. For example, regarding locking and unlocking, security, and/or user authentication of electronic devices, many recent electronic devices use users' biometric information (e.g., fingerprint information) acquired through a biometric sensor.

### DISCLOSURE OF THE INVENTION

### Technical Problem

Various embodiments described herein provide an electronic device capable of both detecting biometric information and providing haptic feedback through a piezoelectric module.

Various embodiments described herein provide an electronic device with improved durability as compared to a piezoelectric module made of a rigid material by disposing a piezoelectric module made of a flexible material on the back surface of a flexible display.

Technical problems to be solved in the present disclosure are not limited to the technical problems to be solved, which have been mentioned above, and other technical problems to be solved that are not mentioned will be clearly understood by those of ordinary skill in the art to which the present disclosure belongs from the following description.

### Technical Solution

According to an aspect of the present disclosure, there is provided an electronic device including a housing and a piezoelectric module positioned in the housing and including a first region for detecting biometric information using ultrasonic waves and a second region for providing haptic feedback, in which the piezoelectric module includes a first electrode layer and a second electrode layer facing each other and a piezoelectric layer positioned between the first electrode layer and the second electrode layer, at least one portion of the piezoelectric layer positioned in the first region of the piezoelectric module vibrates in a first frequency band to emit the ultrasonic waves, and at least one portion of the piezoelectric layer positioned in the second region of the piezoelectric module vibrates in a second frequency band lower than the first frequency band.

According to an aspect of the present disclosure, there is provided an electronic device including a housing, a display positioned in the housing, and a piezoelectric module including a first region positioned on a back surface of the display and detecting biometric information using ultrasonic waves and a second region providing haptic feedback, in which the piezoelectric module includes a first electrode layer including a plurality of first unit electrodes positioned in the first region and a plurality of second unit electrodes positioned in the second region, a second electrode layer facing the first electrode layer, and a piezoelectric layer positioned between the first electrode layer and the second electrode layer, and an area of the first unit electrode is smaller than an area of the second unit electrode.

According to yet another aspect of the present disclosure, there is provided a method including forming a piezoelectric module having a first region for detecting biometric information using ultrasonic waves and a second region for providing haptic feedback, wherein forming the piezoelectric module includes: forming a first electrode layer and a second electrode layer facing each other and positioning a piezoelectric layer between the first electrode layer and the second electrode layer. At least a portion of the piezoelectric layer positioned in the first region of the piezoelectric module vibrates in a first frequency band to emit the ultrasonic waves, and at least a portion of the piezoelectric layer positioned in the second region of the piezoelectric module vibrates in a second frequency band lower than the first frequency band.

### Advantageous Effects

According to various embodiments, an electronic device can both detect biometric information and provide haptic feedback through a piezoelectric module.

According to various embodiments, by positioning a piezoelectric module made of a flexible material on the back surface of a flexible display, the durability of the electronic device can be improved.

Besides, various effects may be provided that are directly or indirectly identified through the present disclosure.

### BRIEF DESCRIPTION OF THE DRAWINGS

FIG. 1 illustrates a block diagram of an electronic device in a network according to various embodiments.

FIG. 2 is a front perspective view of an electronic device according to an embodiment.

FIG. 3 is a rear perspective view of the electronic device illustrated in FIG. 2.

FIG. 4 is an exploded perspective view of the electronic device illustrated in FIG. 2.

FIG. 5 is a plan view illustrating a piezoelectric module included in an electronic device according to an embodiment.

FIG. 6 is a cross-sectional view of the piezoelectric module included in the electronic device according to an embodiment taken along line A-A′ of FIG. 5.

FIG. 7 is a diagram illustrating a transmission mode of ultrasonic vibration in a first region of a piezoelectric module included in an electronic device according to an embodiment.

FIG. 8 is a diagram illustrating a reception mode of ultrasonic vibration in the first region of the piezoelectric module included in the electronic device according to an embodiment.

FIG. 9 is a diagram illustrating a haptic feedback operation of a piezoelectric module included in an electronic device according to an embodiment.

FIG. 10 is a cross-sectional view of an electronic device according to an embodiment.

FIG. 11 is a cross-sectional view of an electronic device according to an embodiment.

FIG. 12 is a cross-sectional view of an electronic device according to an embodiment.

FIG. 13 is a cross-sectional view of an electronic device according to an embodiment.

FIG. 14 is a cross-sectional view of an electronic device according to an embodiment.

FIG. 15 is a plan view illustrating a second unit electrode of a first electrode layer included in a piezoelectric module of an electronic device according to an embodiment.

FIG. 16 is a plan view illustrating a second counter electrode of a second electrode layer included in the piezoelectric module of the electronic device according to an embodiment.

FIG. 17 is a plan view illustrating a second unit electrode of a first electrode layer included in a piezoelectric module of an electronic device according to an embodiment.

FIG. 18 is a plan view illustrating a second counter electrode of a second electrode layer included in the piezoelectric module of the electronic device according to an embodiment.

FIG. 19 is a diagram illustrating a piezoelectric module of an electronic device according to an embodiment.

FIG. 20 is a cross-sectional view of a piezoelectric module of an electronic device according to an embodiment.

FIG. 21 is a diagram illustrating an electronic device for providing haptic feedback according to an embodiment.

FIG. 22 is a diagram illustrating an electronic device for providing haptic feedback according to an embodiment.

FIG. 23 is a diagram illustrating an electronic device for providing haptic feedback according to an embodiment.

FIG. 24 is a diagram illustrating an electronic device according to an embodiment.

With respect to the description of the drawings, the same or similar reference signs may be used for the same or similar elements.

### MODE FOR CARRYING OUT THE INVENTION

Hereinafter, various embodiments disclosed in the present disclosure will be described with reference to the accompanying drawings. However, this is not intended to limit the present disclosure to the specific embodiments, and it is to be construed to include various modifications, equivalents, and/or alternatives of embodiments of the present disclosure.

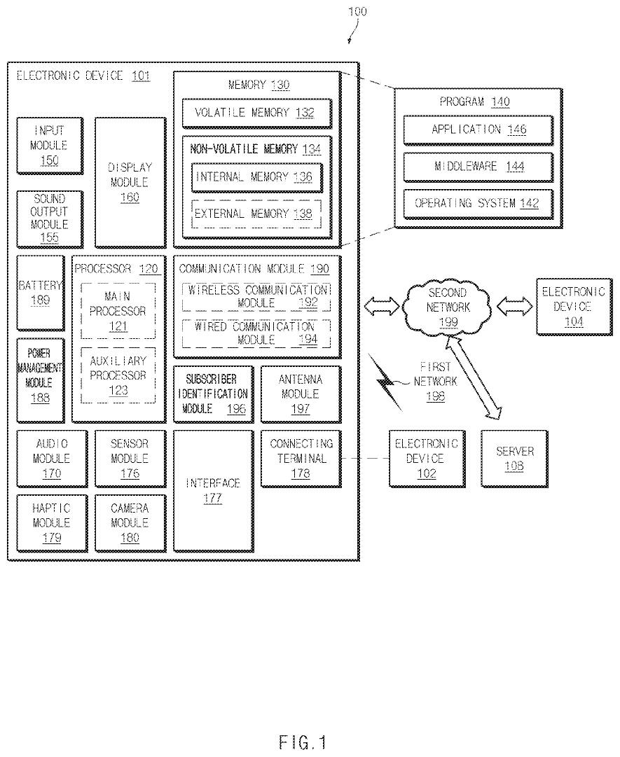

FIG. 1 is a block diagram illustrating an electronic device 101 in a network environment 100 according to various embodiments, Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication nodule 190, a subscriber identification module (SIM) 196, or an antenna module 197. In some embodiments, at least one of the components the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (CPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 1:21 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (ED-MIMO), array antenna, analog beam-forming, or large scale antenna. The wireless communication module 192 may support various requirements specified in the electronic device 101, an external electronic device (e.g., the electronic device 104), or a network system the second network 199). According to an embodiment, the wireless communication module 192 may support a peak data rate (e.g., or more) for implementing eMBB, loss coverage (e.g., 1.64 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIN)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

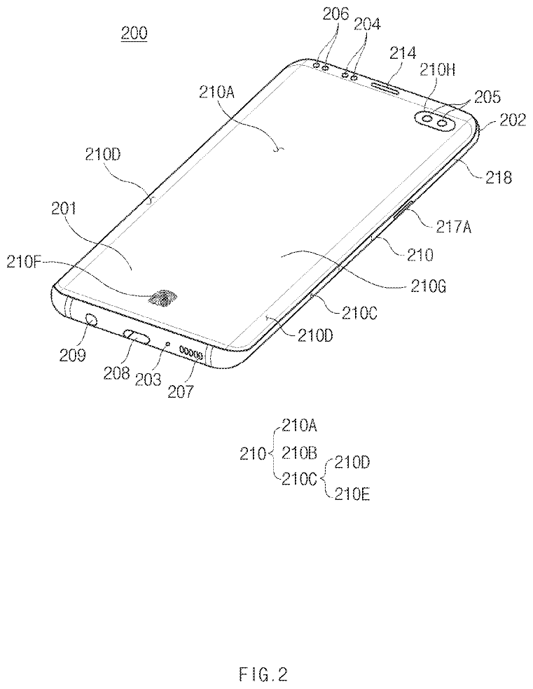

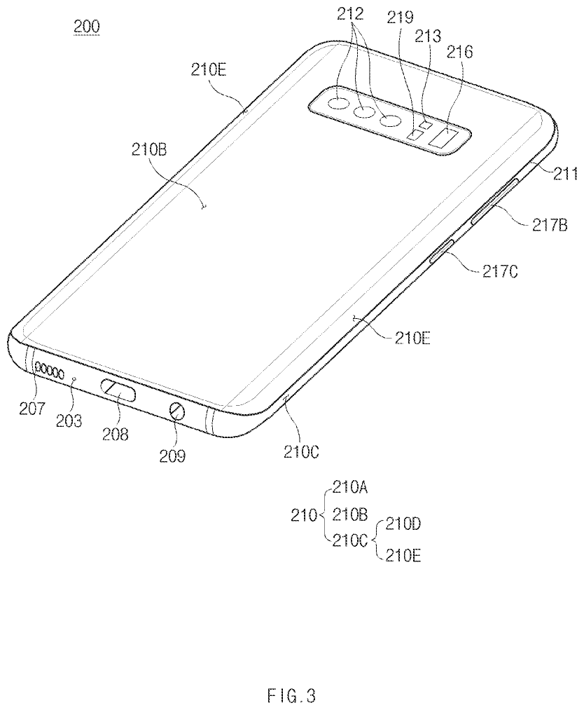

FIG. 2 is a front perspective view of an electronic device according to an embodiment. FIG. 3 is a rear perspective view of the electronic device illustrated in FIG. 2.

Referring to FIGS. 2 and 3, an electronic device 200 (e.g., the electronic device 101 of FIG. 1) according to an embodiment may include a housing 210 including a first surface (or front surface) 210A, a second surface (or back surface) 210B, and a side surface 210C surrounding a space between the first surface 210A and the second surface 210B. In another embodiment (not illustrated), the housing 210 may refer to a structure forming a portion of the first surface 210A, the second surface 210B, and the side surface 210C of FIG. 2.

According to an embodiment, the first surface 210A may be formed by a front plate 202 (e.g., a glass plate or a polymer plate including various coating layers) that is at least partially substantially transparent. The second surface 210B may be formed by a hack plate 211 that is substantially opaque. The back plate 211 may be formed, for example, by coated or colored glass, ceramic, polymer, metal (e.g., aluminum, stainless steel (STS), or magnesium), or a combination of at least two of the above materials. The side surface 210C may be coupled with the front plate 202 and the back plate 211, and may be formed by a side bezel structure (or “side member”) 218 that includes metal and/or polymer. In some embodiments, the back plate 211 and the side bezel structure 218 may be integrally formed, and may include the same material (e.g., a metal material such as aluminum).

In the illustrated embodiment, the front plate 202 may include two first regions 210D that are curved from the first surface 210A toward the back plate 211 and extend seamlessly at both long edges of the front plate 202.

In the illustrated embodiment (see FIG. 3), the back plate 211 may include two second regions 210E that are curved from the second surface 210B toward the front plate 202 and extend seamlessly at the both long edges.

In some embodiments, the front plate 202 (or the back plate 211) may include only one of the first regions 210D (or the second regions 210E). In other embodiments, the front plate 202 (or the back plate 211) may not include some of the first regions 210D (or the second regions 210E).

In various embodiments, when viewed from the side of the electronic device 200, the side bezel structure 218 may have a first thickness (or width) on the sides (e.g., short sides) where the first regions 2101) or the second regions 210E as described above are not included, and may have a second thickness thinner than the first thickness on the sides (e.g., long sides) where the first region 210D or the second region 210E are included.

According to an embodiment, the electronic device 200 may include at least one or more of a display 201, audio modules 203, 207, and 214, sensor modules 204, 216, and 219, camera modules 205, 212, and 213, key input devices 217A, 217B, and 2170, a light emitting element 206, and connector holes 208 and 209. In some embodiments, the electronic device 200 may omit at least one of the components (e.g., key input devices 217A, 217B, and 217C, or the light emitting element 206) or may additionally include other components.

The display 201 may be exposed through a significant portion of the front plate 202, for example. In some embodiments, at least a portion of the display 201 may be exposed through the front plate 202 including the first surface 210A and the first regions 210D of the side surface 210C.

In some embodiments, the edge of the display 201 may be formed to be substantially the same as the outer edge of the front plate 202 adjacent to the edge. In another embodiment (not illustrated), in order to expand the area where the display 201 is exposed, an interval between the outer edge of the display 201 and the outer edge of the front plate 202 may be formed to be substantially the same as each other.

In an embodiment, the surface of the housing 210 (or the front plate 202) may include a screen display region formed by visually exposing the display 201. As an example, the screen display region may include the first surface 210A and the first regions 210D of the side surface.

In the illustrated embodiment, the screen display regions 210A and 210D may include a sensing region 210F configured to acquire biometric information about a user and a haptic region 2106 for providing haptic feedback to the user. Here, it is to be understood that the description that the screen display regions 210A and 210D “may include” the sensing region 210E and the haptic region 2106 means that at least a portion of the sensing region 210F and the haptic region 2106 may overlap the screen display regions 210A and 210D, In other words, the sensing region 210E may mean a region in which visual information may be displayed by the display 201 like other regions of the screen display regions 210A and 210D, and additionally, biometric information (e.g., fingerprint information) about the user may be obtained. The haptic region 2106 may mean a region in which visual information may be displayed by the display 201 like other regions of the screen display regions 210A and 210D, and additionally, haptic feedback is provided to the user.

In the illustrated embodiment, the screen display regions 210A and 210D of the display 201 may include a region 21011 where the first camera device 205 (e.g., a punch hole camera) may be visually exposed. In the region 21011 where the first camera device 205 is visually exposed, at least a portion of the edge may be surrounded by the screen display regions 210A and 210D. In various embodiments, the first camera device 205 may include a plurality of camera devices.

In another embodiment (not illustrated), in a portion of the screen display regions 210A and 210D of the display 201, a recess or opening may be formed, and at least one or more of an audio module 214, the first sensor module 204, and the light emitting element 206 which are aligned with the recess or the opening may be included.

In another embodiment (not illustrated), the display 201 may include, on the back surface of the screen display regions 210A and 210D, at least one or more of the audio module 214, the sensor modules 204, 216, and 219, and the light emitting element 206.

In another embodiment (not illustrated), the display 201 may be coupled with or disposed adjacent to a touch sensing circuit, a pressure sensor capable of measuring the intensity (pressure) of the touch, and/or a digitizer detecting a magnetic field type stylus pen.

In some embodiments, at least some of the sensor modules 204, 216, and 219, and/or at least some of the key input devices 217A, 217B, and 217C may be disposed on the side surface 210C (e.g., the first regions 210D and/or the second regions 210E).

The audio modules 203, 207, and 214 may include a microphone hole 203 and speaker holes 207 and 214. At the microphone hole 203, a microphone for acquiring external sound may be disposed therein, and in some embodiments, a plurality of microphones may be disposed to detect the direction of sound. The speaker holes 207 and 214 may include an external speaker hole 207 and a call receiver hole 214. In some embodiments, the speaker holes 207 and 214 and the microphone hole 203 may be implemented as one hole, or a speaker may be included without the speaker holes 207 and 214 (e.g., a piezo speaker).

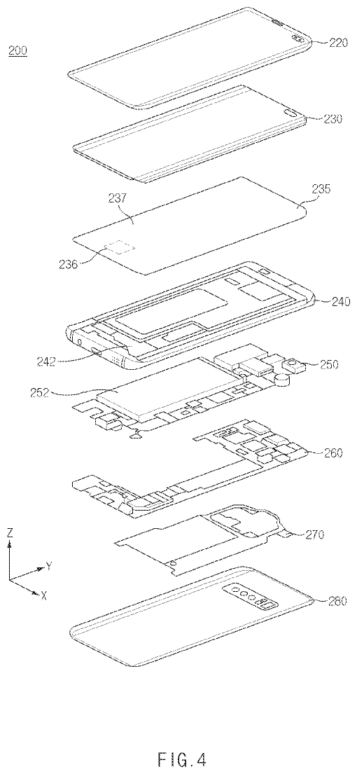

The sensor modules 204, 216, and 219 may generate an electrical signal or data value corresponding to an internal operational state or an external environmental state of the electronic device 200. For example, the sensor modules 204, 216, and 219 may include a first sensor module 204 (e.g., a proximity sensor) disposed on the first surface 210A of the housing 210, a second sensor module 216 (e.g., a time of flight (TOF) camera device) disposed on the second surface 210B of the housing 210, the third sensor module 219 (e.g., an HRM sensor) disposed on the second surface 210B of the housing 210, and/or a fourth sensor module (e.g., a piezoelectric module 235 of FIG. 4) (e.g., a fingerprint sensor) disposed below the display 201.

In various embodiments, the second sensor module 216 may include the TOP camera device for distance measurement.

In various embodiments, at least a portion of the fourth sensor module (e.g., the piezoelectric module 235 of FIG. 4) may be disposed in the screen display region 210A or 210D. For example, the fourth sensor module may be disposed on a back surface of the display 201. That is, the fourth sensor module may not be exposed to the screen display regions 210A and 210D, and the sensing region 210F or the haptic region 210G may be formed on at least a portion of the screen display regions 210A and 210D. In some embodiments (not illustrated), the sensing region 210F may be disposed on the second surface 210B as well as on the first surface 210A (e.g., screen display regions 210A and 210D) of the housing 210.

In various embodiments, the electronic device 200 may further include a sensor module that is not illustrated, for example, at least one of a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or an illuminance sensor.

The camera modules 205, 212, and 213 may include the first camera device 205 (e.g., a punch hole camera device) exposed to the first surface 210A of the electronic device 200, and the second camera device 212 and/or a flash 213 exposed to the second surface 210B.

In the illustrated embodiment, the first camera device 205 may be exposed through a portion of the screen display region 210D of the first surface 210A. For example, the first camera device 205 may be exposed to a portion of the screen display region 210D through an opening (not illustrated) formed in a portion of the display 201.

In the illustrated embodiment, the second camera device 212 may include a plurality of camera devices e.g., dual cameras, triple cameras). However, the second camera device 212 is not necessarily limited to including a plurality of camera devices, and may include a single camera device.

The camera devices 205 and 212 may include one or more lenses, an image sensor, and/or an image signal processor. The flash 213 may include, for example, a light emitting diode or a xenon lamp. In some embodiments, two or more lenses (infrared camera, wide-angle and telephoto lenses) and image sensors may be disposed on one surface of the electronic device 200.

The key input devices 217A, 217B, and 217C may be disposed on the side surface 210C of the housing 210. In other embodiments, the electronic device 200 may not include some or all of the above-mentioned key input devices 217A, 217B, and 217C, and the key input devices 217A, 217B, and 217C which are not included may be implemented in other forms, such as a soft key, on the display 201.

The light emitting element 206 may be disposed on the first surface 210A of the housing 210, for example. The light emitting element 206 may provide, for example, state information about the electronic device 200 in the form of light. In another embodiment, the light emitting element 206 may provide, for example, a light source in conjunction with the operation of the first camera device 205. The light emitting element. 206 may include, for example, an LED, an IR LED, and a xenon lamp.

The connector holes 208 and 209 may include a first connector hole 208 capable of accommodating a connector (for example, a USB connector) for transmitting and receiving electric power and: or data to and from an external electronic device, and/or a second connector hole 209 (e.g., an earphone jack) capable of accommodating a connector for transmitting and receiving audio signals to and from an external electronic device.

FIG. 4 is an exploded perspective view of the electronic device illustrated in FIG. 2. Referring to FIG. 4, the electronic device 200 may include a front plate 220, a display 230 (e.g., the display 201 of FIG. 2), the piezoelectric module 235, a side member 240, a first support member 242 (e.g., a bracket), a printed circuit board 250, a battery 252, a second support member 260 (e.g., a rear case), an antenna 270, and a back plate 280. In some embodiments, the electronic device 200 may omit at least one of the components the first support member 242 or the second support member 260) or may additionally include other components not shown. At least one of the components of the electronic device 200 may be the same as or similar to at least one of the components of the electronic device 200 of FIG. 2 or FIG. 3, and the description thereof will not be repeated below.

The display 230 may be positioned below the front plate 220 and display a screen.

The piezoelectric module 235 may be positioned below the display 230. The piezoelectric module 235 may be positioned between the display 230 and the side member 240. The piezoelectric module 235 may overlap at least a portion of the display 230. The piezoelectric module 235 may include a first region 236 (e.g., the sensing region 210F of FIG. 2) for obtaining biometric information (e.g., fingerprint information) and a second region 237 (e.g., the haptic region 210G of FIG. 2) for providing haptic feedback to the user.

The first support member 242 may be disposed inside the electronic device 200 to be connected to the side member 240 or may be integrally formed with the side member 240. The first support member 242 may be formed of, for example, a metal material and/or a non-metal (e.g., polymer) material. The first support member 242 may have the display 230 and/or the piezoelectric module 235 coupled to one surface and the printed circuit board 250 coupled to the other surface.

The printed circuit board 250 may be equipped with a processor, memory, and/or interface. The processor may include, for example, one or more of a central processing unit, an application processor, a graphic processing unit, an image signal processor, a sensor hub processor, or a communication processor.

The memory may include, for example, a volatile memory or a non-volatile memory.

The interface may include, for example, a high-definition multimedia interface (HDMI), a universal serial bus (USB) interface, a secure digital (SD) card interface, and/or an audio interface. The interface may electrically or physically connect the electronic device 200 to an external electronic device, for example, and may include a USB connector, an SD card/MMC connector, or an audio connector.

The battery 252 may be a device for supplying power to at least one of the components of the electronic device 200, and may include, for example, a primary cell which is not rechargeable, a secondary cell which is rechargeable, or a fuel cell. At least a portion of the battery 252 may be disposed, for example, on substantially the same plane as the printed circuit board 250. The battery 252 may be integrally disposed inside the electronic device 200, or may be disposed to be detachable from the electronic device 200.

The antenna 270 may be disposed between the back plate 280 and the battery 252. The antenna 270 may include, for example, a near field communication (NFC) antenna, a wireless charging antenna, and/or a magnetic secure transmission (MST) antenna. The antenna 270 may, for example, perform short range communication with an external device, or may wirelessly transmit and receive electric power required for charging. In another embodiment, the antenna structure may be formed by the side member 240 and/or a portion of the first support member 242 or a combination thereof.

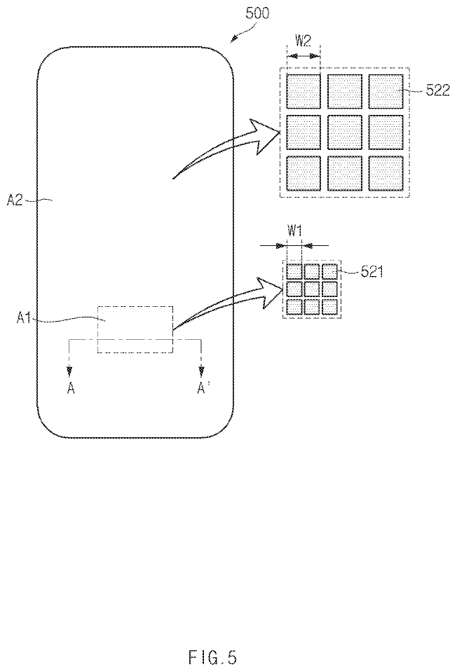

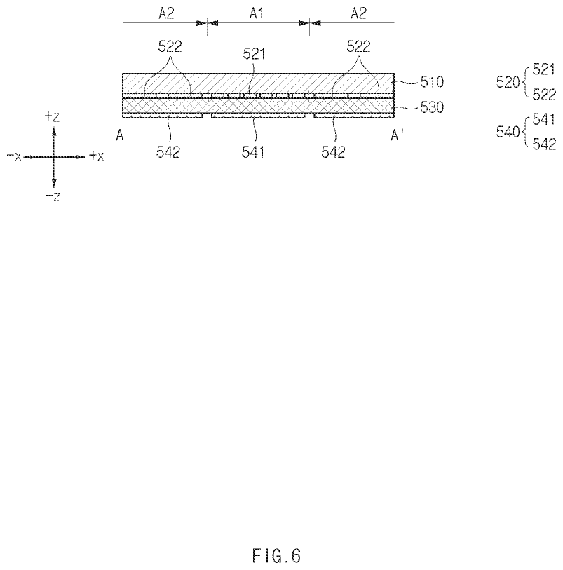

Hereinafter, a piezoelectric module 500 (e.g., the piezoelectric module 235 of FIG. 4) included in an electronic device according to an embodiment will be described with reference to FIGS. 5 and 6. FIG. 5 is a plan view illustrating the piezoelectric module 500 included in the electronic device according to an embodiment. FIG. 6 is a cross-sectional view of the piezoelectric module 500 included in the electronic device according to an embodiment taken along line A-A′ of FIG. 5.

Referring to FIGS. 5 and 6, the piezoelectric module 500 may include a first region A1 for detecting biometric information (e.g., fingerprint information) about a user using ultrasonic waves and a second region A2 for providing a haptic. The first region A1 of the piezoelectric module 500 may be disposed to correspond to a sensing region (e.g., first region 236 of FIG. 4 and/or the sensing region 210F of FIG. 2) for detecting biometric information in an electronic device (e.g., the electronic device 200 of FIG. 2), The second region A2 of the piezoelectric module 500 may be disposed to correspond to a haptic region (e.g., second region 237 of FIG. 4 and/or the haptic region 210G of FIG. 2) for providing haptic feedback in an electronic device (e.g., the electronic device 200 of FIG. 2).

The piezoelectric module 500 may include a substrate 510, a first electrode layer 520, a second electrode layer 540, and a piezoelectric layer 530.

The substrate 510 may include a flexible material that may be curved, bent, folded or rolled. For example, the substrate 510 may include a polymer such as polyimide, polyamide, polycarbonate, or polyethylene terephthalate. A conductive pattern (not illustrated) and an electrical element (not illustrated) far driving the piezoelectric module 500 may be positioned on the substrate 510.

The first electrode layer 520 may be positioned on one surface (e.g., a surface in a −z direction) of the substrate 510. The first electrode layer 520 may be adjacent to the substrate 510 in the −Z direction. The first electrode layer 520 may include a plurality of first unit electrodes 521 positioned in the first region A1 and a plurality of second unit electrodes 522 positioned in the second region A2. A width w1 (or area) of one first unit electrode 521 may be smaller than a width w2 (or area) of one second unit electrode 522. For example, the width w1 of the first unit electrode 521 may be about 10 μm to about 100 μm. The width w2 of the second unit electrode 522 may be about 1 mm to about 100 mm.

The second electrode layer 540 may be positioned on the first electrode layer 520 in the −Z direction and may face the first electrode layer 520. The second electrode layer 540 may include a first counter electrode 541 positioned in the first region A1 and a second counter electrode 542 positioned in the second region A2. According to an embodiment, the first counter electrode 541 and the second counter electrode 542 may not be electrically connected and receive different voltages. According to another embodiment, the first counter electrode 541 and the second counter electrode 542 may be electrically connected and receive the same voltage. Unlike the illustration, the first electrode layer 520 may, alternatively, be integrally formed on the entire region of the first region A1 and the second region A2.

The piezoelectric layer 530 may be positioned between the first electrode layer 520 and the second electrode layer 540. The piezoelectric layer 530 may be positioned in the first region A1 and the second region A2. The piezoelectric layer 530 may include a piezoelectric material. For example, the piezoelectric layer 530 may contain a polymer (e.g., poly(vinylidene fluoride) and poly(vinylidene fluoride-trifluoroethylene), PVDF and PVDF-TrFE, respectively) and may be flexible. The piezoelectric layer 530 may vibrate by contracting or expanding based on a difference between voltages applied to the first electrode layer 520 and the second electrode layer 540. The degree of contraction or expansion of the piezoelectric layer 530 in each direction according to an electric field applied to the piezoelectric layer 530 may be determined based on a piezoelectric strain constant of the piezoelectric material. At least one region of the piezoelectric layer 530 positioned in the first region A1 may vibrate in a first frequency band based on a difference between voltages applied to the first unit electrode 521 of the first electrode layer 520 and the first counter electrode 541 of the second electrode layer 540. At least one region of the piezoelectric layer 530 positioned in the second region A2 may vibrate in a second frequency band based on a difference between voltages applied to the second unit electrode 522 of the first electrode layer 520 and the second counter electrode 542 of the second electrode layer 540. The second frequency band may be lower than the first frequency band.

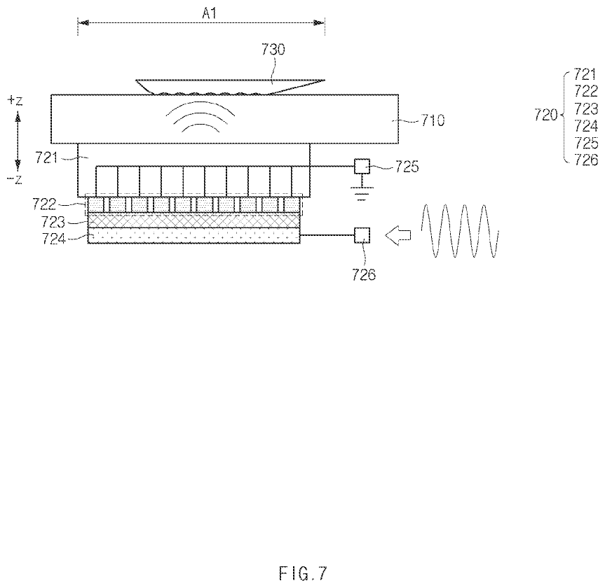

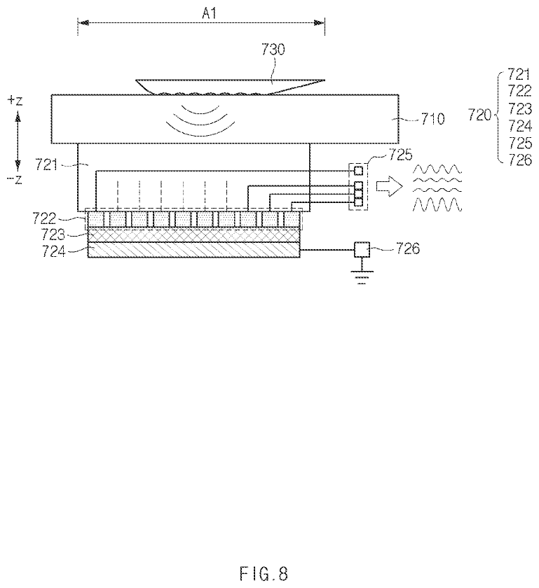

Hereinafter, an operation of detecting biometric information in a first region A1 of a piezoelectric (nodule included in an electronic device according to an embodiment will be described with reference to FIGS. 7 and 8. FIG. 7 is a diagram illustrating a transmission mode of ultrasonic vibration in a first region A1 of a piezoelectric module included in an electronic device according to an embodiment. FIG. 8 is a diagram illustrating a reception mode of ultrasonic vibration in the first region A1 of the piezoelectric module included in the electronic device according to an embodiment.

Referring to FIGS. 7 and 8, the electronic device according to an embodiment may include a display 710 and a piezoelectric module 720 (e.g., the piezoelectric module 235 of FIG. 4 or the piezoelectric module 500 of FIG. 5) positioned on the back surface of the display 710.

The display 710 may display the screen in a +Z direction. In a mode for detecting biometric information, an external object 730 (e.g., a finger) may be disposed on a surface of the display 710 in the ±Z direction.

The piezoelectric module 720 may include a first region A1 for detecting biometric information. The piezoelectric module 720 may include a substrate 721, a first unit electrode 722 of a first electrode layer, a first counter electrode 724 of a second electrode layer, a piezoelectric layer 723 between the first unit electrode 722 and the first counter electrode 724, a first terminal 725, and a second terminal 726. The first terminal 725 may be electrically connected to the first unit electrode 722, and the second terminal 726 may be electrically connected to the first counter electrode 724, In some embodiments, the first unit electrode 722 includes a plurality of electrode elements and the first terminal 725 includes a plurality of terminal elements. In some embodiments, each of the plurality of electrode elements is coupled to a respective one of the plurality of terminal elements (as shown).

First, referring to FIG. 7, in the transmission mode of the piezoelectric module 720, the first terminal 725 may be grounded, and the second terminal 726 may apply an electrical signal (denoted in FIG. 7 by a stylized sinusoidal wave) to the first counter electrode 724. The piezoelectric layer 723 may contract or expand by an electrical signal applied to the first counter electrode 724 and vibrate in the +/−Z direction in a first frequency band (e.g., 10 MHz to 20 MHz). The piezoelectric layer 723 may generate ultrasonic waves by vibrating in the first frequency band. The ultrasonic waves generated in the piezoelectric module 720 may be transmitted to the object 730 disposed on the display 710 and reflected from the object 730.

Referring to FIG. 8, in the reception mode of the piezoelectric module 720, the second terminal 726 may be grounded. The piezoelectric module 720 may detect biometric information (e.g., fingerprint information) by detecting ultrasonic waves (denoted in FIG. 8 by three concentric arcs) reflected from the object 730. The ultrasonic waves reflected from the object 730 may have different reflection patterns according to ridges and valleys of a fingerprint of the object 730. The first unit electrode 722 may convert the intensity of ultrasonic vibration reflected for each pixel into an electrical signal (denoted in FIG. 8 by four stylized waveforms). The piezoelectric module 720 may detect biometric information by detecting a reflection pattern of ultrasonic waves according to the valleys and ridges of the fingerprint for each pixel through the first unit electrode 722.

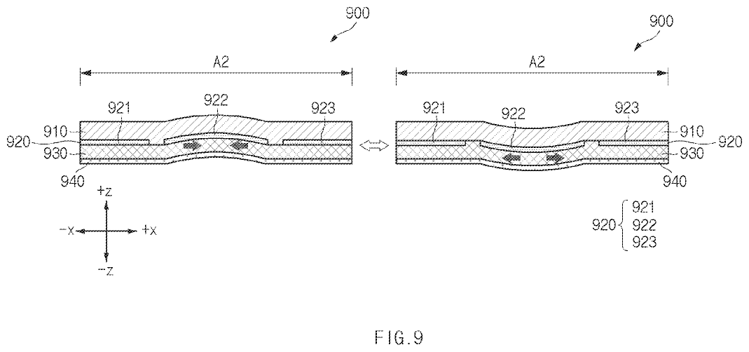

Hereinafter, a haptic feedback operation in a second region A2 of a piezoelectric module 900 included in an electronic device according to an embodiment will be described with reference to FIG. 9. FIG. 9 is a diagram illustrating the haptic feedback operation of the piezoelectric module 900 included in the electronic device according to an embodiment.

Referring to FIG. 9, the piezoelectric module 900 (e.g., the piezoelectric module 235 of FIG. 4, the piezoelectric module 500 of FIG. 5, or the piezoelectric module 720 of FIG. 7) tray include a second region A2 for providing haptic feedback. The piezoelectric module 900 may include a substrate 910, a plurality of second unit electrodes 921, 922, and 923 of a first electrode layer 920, a second counter electrode 940 of a second electrode layer, and a piezoelectric layer 930 positioned between the plurality of second unit electrodes 921, 922, and 923 of the first electrode layer 920 and the second counter electrode 940.

The sizes of the plurality of second unit electrodes 921, 922, and 923 in the second region A2 of the piezoelectric module 900 may be larger than those of the first unit electrodes 722 in the first region A1 (refer to FIGS. 7 and 8), so that contraction or expansion of the piezoelectric layer 930 in a +/−X direction due to the difference between voltages of the plurality of second unit electrodes 921, 922, and 923 and the second counter electrode 940 may be larger in the second region A2 than in the first region A1, Accordingly, the piezoelectric module 900 may provide haptic feedback to the user by using deformation or vibration of the surface of the electronic device due to contraction or expansion of the piezoelectric layer 930 in the +/−X direction.

For example, a voltage may be applied to any one electrode among the plurality of second unit electrodes 921, 922, and 923. For example, a voltage may be applied to the second unit electrode 922 to have a predetermined voltage difference with the second counter electrode 940, and when a voltage is applied to the adjacent second unit electrodes 921 and 923 so that the voltage difference with the second counter electrode 940 becomes zero, the piezoelectric layer 930 corresponding to the second unit electrode 922 may contract in the +/−X direction. When the piezoelectric layer 930 contracts in the +/−X direction, a region corresponding to the second unit electrode 92:2 in the piezoelectric module 900 may protrude in the +Z direction. When the polarity of the voltage applied to the second unit electrode 922, which is one second unit electrode among the plurality of second unit electrodes 921, 922, and 923, is changed, the piezoelectric layer 930 corresponding to the second unit electrode 922 may expand in the +/−X direction. When the piezoelectric layer 930 expands in the +/−X direction, a region corresponding to the second unit electrode 922 in the piezoelectric module 900 may protrude in the −Z direction.

The voltage applied to the plurality of second unit electrodes 921, 922, and 923 may be determined based on a piezoelectric strain constant of a piezoelectric material of the piezoelectric layer 930. The piezoelectric layer 930 may contract or expand by an electrical signal applied to the plurality of second unit electrodes 921, 922, and 923 and vibrate in the +/−X direction in a second frequency band (e.g., DC (0 Hz) to 20 Hz). For example, the second frequency band may be lower than the audible frequency band. The substrate 910 and the display disposed on the substrate 910 may be deformed in the +/−Z direction by contraction or expansion of the piezoelectric layer 930 in the +/−X direction.

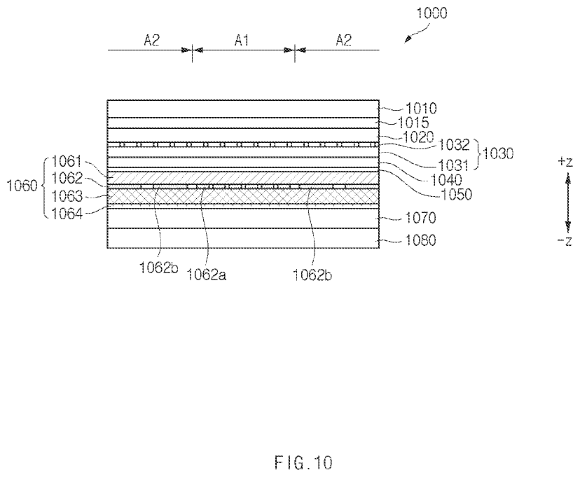

Hereinafter, an electronic device 1000 according to an embodiment will be described with reference to FIG. 10. FIG. 10 is a cross-sectional view of the electronic device 1000 according to an embodiment. The electronic device 1000 according to an embodiment (e.g., the electronic device 101 of FIG. 1 or the electronic device 200 of FIG. 2) may include a window 1010, an adhesive layer 1015, a polarization layer 1020, a display 1030, a barrier layer 1040, a black coating layer 1050, a piezoelectric module 1060, a back layer 1070, and a cushion layer 1080.

The window 1010 may transmit light by including a transparent material.

The adhesive layer 1015 may cause the window 1010 and the polarization layer 1020 to adhere to each other between the window 1010 and the polarization layer 1020. The adhesive layer 1015 may be optical clear adhesive (OCA) including a transparent material.

The polarization layer 1020 may be positioned below the window 1010 (e.g., in the −z direction). The polarization layer 1020 may prevent external light from being reflected and viewed.

The display 1030 may include a panel substrate 1031 and light emitting elements 1032 disposed on the panel substrate 1031 (e.g., in the +z direction). The panel substrate 1031 may include a flexible material. The display 1030 may display an image through the light emitting elements 1032. For example, the light emitting elements 1032 may include organic light emitting diodes (OLEDs).

The harrier layer 1040 may be positioned below the display 1030 in the −z direction).

The black coating layer 1050 may be positioned below the harrier layer 1040 (e.g., in the −z direction). The black coating layer 1050 may prevent light emitted from the display 1030 from traveling toward the back surface (e.g., −Z direction).

The piezoelectric module 1060 may include a substrate 1061 (e.g., the substrate 710, the substrate 910), a first electrode layer 1062 (e.g., first electrode layer 520, first electrode layer 920), a second electrode layer 1064 (e.g., second electrode layer 540), and a piezoelectric layer 1063 (e.g., piezoelectric layer 723, piezoelectric layer 930). The first electrode layer 1062 may include first unit electrodes 1062a (e.g., first unit electrodes 722) positioned in a first region A1 and second unit electrodes 1062b (e.g., second unit electrodes 921, 922, and 923) positioned in a second region A2. The second electrode layer 1064 may be integrally positioned in the first region A1 and the second region A2.

The back layer 1070 may be positioned below the piezoelectric module 1060 (e.g., in the −z direction). The back layer 1070 may reflect ultrasonic waves to prevent the ultrasonic waves from traveling toward the back surface of the electronic device 1000 (e.g., in the −Z direction).

The cushion layer 1080 may be positioned below the back layer 1070 (e.g., in the −z direction). The cushion layer 1080 may protect the display 1030 and the piezoelectric module 1060 by absorbing impact.

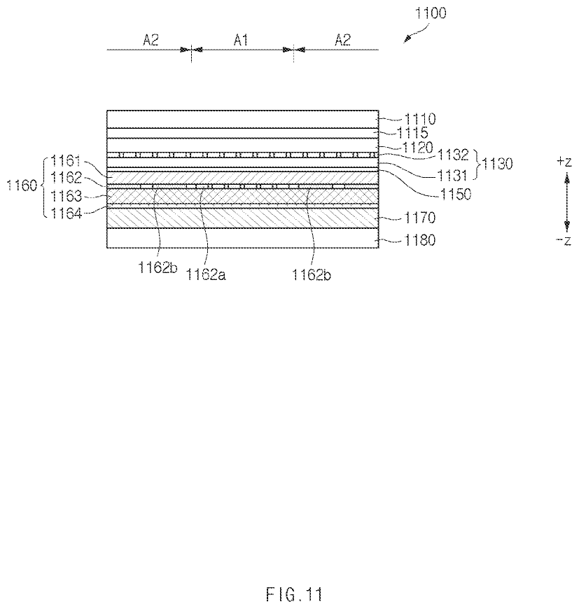

Hereinafter, an electronic device 1100 according to an embodiment will be described with reference to FIG. 11. FIG. 11 is a cross-sectional view of the electronic device 1100 according to an embodiment. The electronic device 1100 according to an embodiment (e.g., the electronic device 101 of FIG. 1 or the electronic device 200 of FIG. 2) may include a window 1110, an adhesive layer 1115, a polarization layer 1120, a display 1130, a black coating layer 1150, a piezoelectric module 1160, a back layer 1170, and a cushion layer 1180.

The display 1130 may include a panel substrate 1131 and light emitting elements 1132 disposed on the panel substrate 1131 (e.g., in the +z direction).

The piezoelectric module 1160 may include a substrate 1161 (e.g., the substrate 710, the substrate 910), a first electrode layer 1162 (e.g., first electrode layer 520, first electrode layer 920), a second electrode layer 1164 (e.g., second electrode layer 540), and a piezoelectric layer 1163 (e.g., piezoelectric layer 723, piezoelectric layer 930). The first electrode layer 1162 may include first unit electrodes 1162a positioned in a first region A1 and second unit electrodes 1162b positioned in a second region A2. The second electrode layer 1164 may be integrally positioned in the first region A1 and the second region A2.

The electronic device 1100 according to an embodiment may include a barrier layer (e.g., the barrier layer 1040 of FIG. 10) as a substrate 1161 of the piezoelectric module 1160.

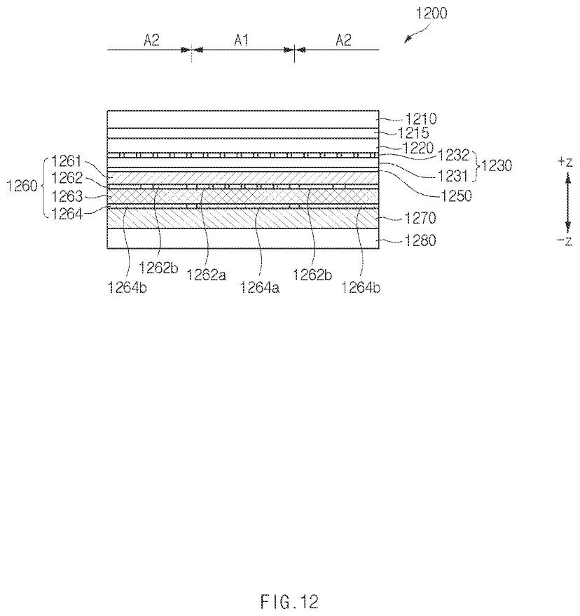

Hereinafter, an electronic device 1200 according to an embodiment will be described with reference to FIG. 12. FIG. 12 is a cross-sectional view of the electronic device 1200 according to an embodiment.

The electronic device 1200 according to an embodiment (e.g., the electronic device 101 of FIG. 1 or the electronic device 200 of FIG. 2) may include a window 1210, an adhesive layer 1215, a polarization layer 1220, a display 1230, a black coating layer 1250, a piezoelectric module 1260, a back layer 1270, and a cushion layer 1280.

The display 1230 may include a panel substrate 1231 and light emitting elements 1232 disposed on the panel substrate 1231 (e.g., in the +z direction).

The piezoelectric module 1260 may include a substrate 1261 (e.g., the substrate 710, the substrate 910), a first electrode layer 1262 (e.g., first electrode layer 520, first electrode layer 920), a second electrode layer 1264 (e.g., second electrode layer 540), and a piezoelectric layer 1263 (e.g., piezoelectric layer 723, piezoelectric layer 930). The first electrode layer 1262 may include first unit electrodes 1262a positioned in a first region A1 and second unit electrodes 1262h positioned in a second region A2. The second electrode layer 1264 may include a first counter electrode 1264a positioned in the first region A1 and second counter electrodes 1264b positioned in the second region A2. The second electrode layer 1264 of the piezoelectric module 1260 included in the electronic device 1200 according to an embodiment may include the first counter electrode 1264a and second counter electrodes 1264b so that the first region A1 and the second region A2 are individually controlled.

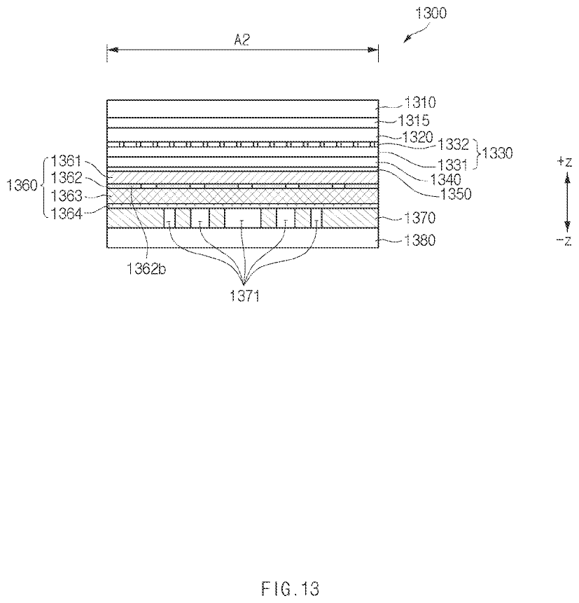

Hereinafter, an electronic device 1300 according to an embodiment will be described with reference to FIG. 13. FIG. 13 is a cross-sectional view of the electronic device 1300 according to an embodiment.

The electronic device 1300 according to an embodiment (e.g., the electronic device 101 of FIG. 1 or the electronic device 200 of FIG. 2) may include a window 1310, an adhesive layer 1315, a polarization layer 1320, a display 1330, a barrier layer 1340, a black coating layer 1350, a piezoelectric module 1360, a hack layer 1370, and a cushion layer 1380.

The display 1330 may include a panel substrate 1331 and light emitting elements 1332 disposed on the panel substrate 1331 (e.g., in the direction).

The piezoelectric module 1360 may include a substrate 1361 (e.g., the substrate 710, the substrate 910), a first electrode layer 1362 (e.g., first electrode layer 520, first electrode layer 920), a second electrode layer 1364 (e.g., second electrode layer 540), and a piezoelectric layer 1363 (e.g., piezoelectric layer 723, piezoelectric layer 930). The first electrode layer 1362 may include first unit electrodes (not illustrated) positioned in a first region (not illustrated) and second unit electrodes 1362b positioned in a second region A2.

The back layer 1370 may include a plurality of holes 1371 in the second region A2. Since the back layer 1370 includes the plurality of holes 1371, the second region A2 of the piezoelectric module 1360 may be easily stretched and vibration for haptic feedback may be effectively performed. Unlike the illustration, the cushion layer 1380 may also include a plurality of holes.

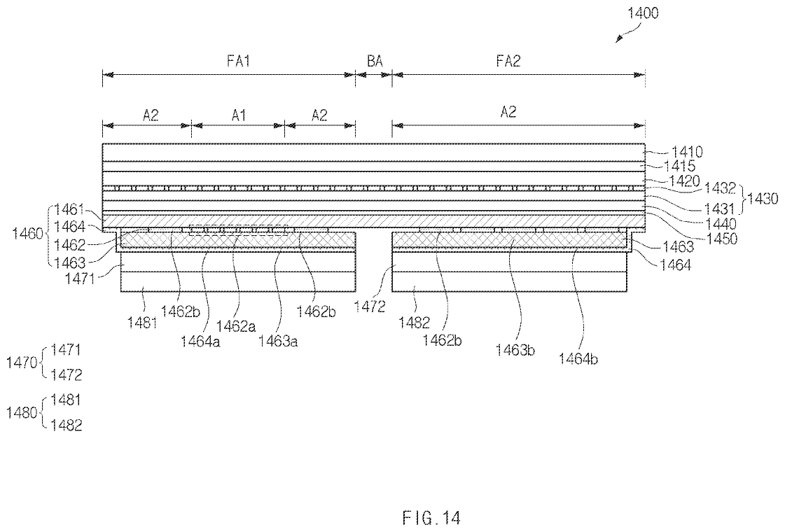

Hereinafter, an electronic device 1400 according to an embodiment will be described with reference to FIG. 14. FIG. 14 is a cross-sectional view of an electronic device according to an embodiment.

An electronic device 1400 according to an embodiment (e.g., the electronic device 101 of FIG. 1 or the electronic device 200 of FIG. 2) may be a foldable electronic device 1400 in which at least one region is capable of being folded or unfolded. The electronic device 1400 according to an embodiment may include a foldable bending region BA, and a first flat region FA1 and a second flat region FA2 positioned on both sides of the bending region BA. FIG. 14 illustrates an unfolded state of the electronic device 1400. The electronic device 1400 may be folded such that the first flat region FA1 and the second flat region FA2 face each other.

The electronic device 1400 according to an embodiment may include a Window 1410, an adhesive layer 1415, a polarization layer 1420, a display 1430, a barrier layer 1440, a black coating layer 1450, a piezoelectric nodule 1460, a back layer 1470, and a cushion layer 1480.

The display 1430 may include a panel substrate 1431 and light emitting elements 1432 disposed on the panel substrate 1431 (e.g., in the direction).

In the piezoelectric module 1460, a first region A1 for detecting biometric information and second regions A2 for providing haptic feedback may be positioned in a region other than the bending region BA. In the piezoelectric module 1460, the first region A1 may be positioned in at least one of the first flat region FA1 and the second flat regions FA2. In the piezoelectric module 1460, the second regions A2 may be positioned in remaining regions of the first flat region FA1 and the second flat region FA2 other than the first region A1.

The piezoelectric module 1460 may include a substrate 1461 (e.g., the substrate 710, the substrate 910), a first electrode layer 1462 (e.g., first electrode layer 520, first electrode layer 920), a second electrode layer 1464 (e.g., second electrode layer 540), and a piezoelectric layer 1463 (e.g., piezoelectric layer 723, piezoelectric layer 930).

The first electrode layer 1462 may include first unit electrodes 1462a positioned in the first region A1 and second unit electrodes 1462b positioned in second regions A2. The first electrode layer 1462, the second electrode layer 1464, and the piezoelectric layer 1463 of the piezoelectric module 1460 may be removed from the bending region BA. The piezoelectric layer 1463 may include a first piezoelectric layer 1463a positioned on the first flat region FA1 and a second piezoelectric layer 1463h positioned on the second flat region FA2. The first piezoelectric layer 1463a and the second piezoelectric layer 1463b may be positioned on both sides of the bending region BA and spaced apart from each other. The second electrode layer 1464 may include a first sub-electrode layer 1464a positioned on the first flat region FA1 and a second sub-electrode layer 1464b positioned on the second flat region FA2. The first sub-electrode layer 1464a and the second sub-electrode layer 1464b may be positioned on both sides of the bending area BA and spaced apart from each other. According to an embodiment, the substrate 1461 may be removed from the bending region BA.

The back layer 1470 may be removed from the bending region BA. For example, the back layer 1470 may include a first back layer 1471 positioned on the first flat region FA1 and a second back layer 1472 positioned on the second flat region FA2. The first back layer 1471 and the second back layer 1472 may be positioned on both sides of the bending region BA and spaced apart from each other.

The cushion layer 1480 may be removed from the bending region BA. For example, the cushion layer 1480 may include a first cushion layer 1481 positioned on the first flat region FA1 and a second cushion layer 1482 positioned on the second flat region FA2. The first cushion layer 1481 and the second cushion layer 1482 may be positioned on both sides of the bending region BA and spaced apart from each other.

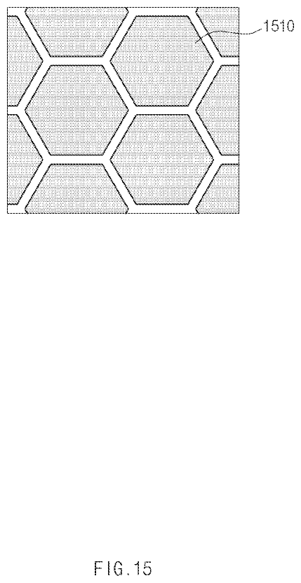

FIG. 15 is a plan view illustrating a second unit electrode 1510 of a first electrode layer included in a piezoelectric module of an electronic device according to an embodiment.

The second unit electrode 1510 may be located in a second region A2 of the piezoelectric module, and a voltage for haptic feedback may be applied to the second unit electrode 1510. According to an embodiment, the second unit electrode 1510 may have a hexagonal shape.

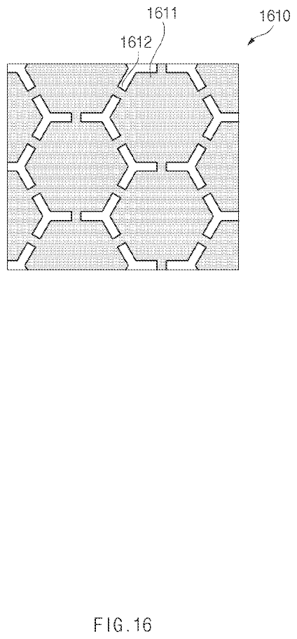

FIG. 16 is a plan view illustrating a second counter electrode 1610 of a second electrode layer included in the piezoelectric module of the electronic device according to an embodiment.

The second counter electrode 1610 may face a second unit electrode (e.g., the second unit electrode 1510 of FIG. 15) in the second region A2 of the piezoelectric module. A voltage for haptic feedback may be applied to the second counter electrode 1610. According to an embodiment, the second counter electrode 1610 may include hexagonal body parts 1611 and connecting parts 1612 connecting the body parts 1611.

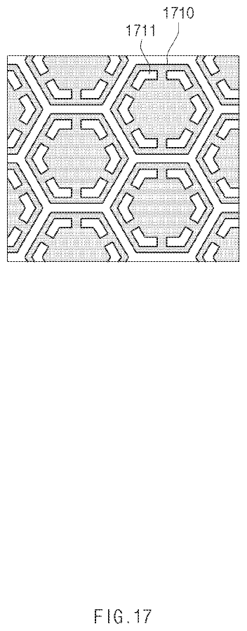

FIG. 17 is a plan view illustrating a second unit electrode 1710 of a first electrode layer included in a piezoelectric module of an electronic device according to an embodiment.

The second unit electrode 1710 may be positioned in a second region A2 of the piezoelectric module, and a voltage for haptic feedback may be applied to the second unit electrode 1710. According to an embodiment, the second unit electrode 1710 may have a hexagonal shape. The second unit electrode 1710 may include at least one hole 1711 positioned along an outer edge. In some embodiments, one or more holes of the at least one hole 1711 are conformally aligned to an outermost perimeter of the second unit electrode 1710 (as shown). In some embodiments, each hole of the at least one hole 1711 has a same, or substantially same, shape (that is, the holes can have rotational symmetry). Accordingly, the amount of deformation of the outer edge portion of the second unit electrode 1710 may be reduced, and the second unit electrode 1710 may be easily elongated when the piezoelectric module vibrates.

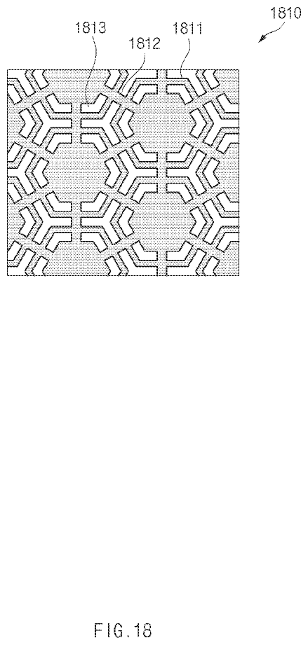

FIG. 18 is a plan view illustrating a second counter electrode 1810 of a second electrode layer included in the piezoelectric module of the electronic device according to an embodiment.

The second counter electrode 1810 may face a second unit electrode (e.g., the second unit electrode 1510 of FIG. 15) in the second region A2 of the piezoelectric module. A voltage for haptic feedback may be applied to the second counter electrode 1810. According to an embodiment, the second counter electrode 1810 may include hexagonal body parts 1811, connecting parts 1812 connecting the body parts 1811, and at least one hole 1813 positioned along an outer edge of the body parts 1811. In some embodiments, one or more holes of the at least one hole 1813 are conformally aligned to the outer edge of the body parts 1811 (as shown). In some embodiments, each hole of the at least one hole 1813 has a same, or substantially same, shape (that is, the holes can have rotational symmetry). In some embodiments, one or more holes of the at least one hole 1813 are conformally aligned to a connecting part of the connecting parts 1812. For example, sidewalls of each hole can be aligned to sidewalls of a respective connecting part (as shown).

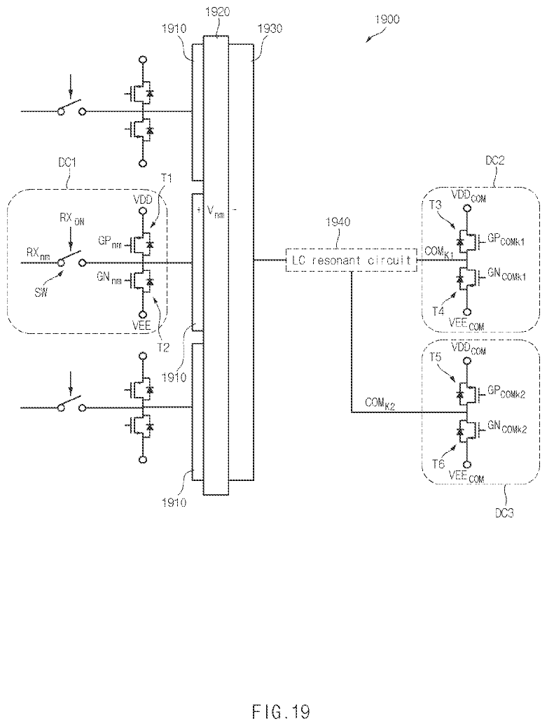

FIG. 19 is a diagram illustrating a piezoelectric module 1900 of an electronic device according to an embodiment. In FIG. 19, first unit electrodes of a first electrode layer are described, but the configuration of FIG. 19 may be equally applied to second unit electrodes of a first electrode layer.

Referring to FIG. 19, the piezoelectric module 1900 may include first unit electrodes 1910 (or second unit electrodes) of the first electrode layer, a piezoelectric layer 1920, a second electrode layer 1930, first driving circuits DC1 electrically connected to the first unit electrodes 1910, respectively, an LC resonant circuit 1940 electrically connected to the second electrode layer 1930, and a second driving circuit DC2 and a third driving circuit DC3 electrically connected to the LC resonant circuit 1940. According to embodiments, the LC resonant circuit 1940 and the third driving circuit DC3 may be omitted. The piezoelectric layer 1920 may contract or expand based on a voltage difference Vₙₘ between the first unit electrodes 1910 and the second electrode layer 1930.

The first driving circuit DC1 may include a first transistor T1, a second transistor T2, and a switch SW. For example, the first transistor T1 may be a P-type transistor, and the second transistor T2 may be an N-type transistor. The first transistor T1 may be turned on or off by a first gate signal A source electrode of the first transistor T1 may be connected to a VDD voltage line, and a drain electrode of the first transistor T1 may be connected to the switch SW, the second transistor T2, and the first unit electrode 1910. The second transistor T2 may be turned on or off by a second gate signal GNₙₘ. A source electrode of the second transistor T2 may be connected to a VEE voltage line, and a drain electrode of the second transistor T2 may, be connected to the switch SW, the first transistor T1, and the first unit electrode 1910. When the first transistor T1 is turned on and the second transistor T2 is turned off, a VDD voltage may be applied to the first unit electrode 1910. When the first transistor T1 is turned off and the second transistor T2 is turned on, a VEE voltage may be applied to the first unit electrode 1910.

The second driving circuit DC2 may include a third transistor T3 and a fourth transistor T4. For example, the third transistor T3 may be a P-type transistor, and the fourth transistor T4 may be an N-type transistor. The third transistor T3 may be turned on or off by a third gate signal GP_{comk1}. A source electrode of the third transistor T3 may be connected to a VDD_{COM} voltage line, and a drain electrode of the third transistor T3 may be connected to the fourth transistor T4 and the LC resonant circuit 1940. The fourth transistor T4 may be turned on or off by the fourth gate signal GN_{comk1}. A source electrode of the fourth transistor T4 may be connected to a VEE_{COM} voltage line, and a drain electrode of the fourth transistor T4 may be connected to the third transistor T3 and the LC resonant circuit 1940. In an embodiment where the LC resonant circuit 1940 and the third driving circuit DC3 are not included, the second driving circuit. DC2 may be directly connected to the second electrode layer 1930. In this case, when the third transistor T3 is turned on and the fourth transistor T4 is turned off, the VDD_{COM} voltage may be applied to the second electrode layer 1930. When the third transistor T3 is turned off and the fourth transistor T4 is turned on, a VEE_{COM} voltage may be applied to the second electrode layer 1930.

The third driving circuit DC3 may include a fifth transistor T5 and a sixth transistor T6. For example, the fifth transistor T5 may be a P-type transistor, and the sixth transistor T6 may be an N-type transistor. The fifth transistor T5 may be turned on or off by a fifth gate signal GP_{comk2}. A source electrode of the fifth transistor T5 may be connected to a VDD_{COM} voltage line, and a drain electrode of the fifth transistor T5 may be connected to the sixth transistor T6 and the LC resonant circuit 1940, The sixth transistor T4 may be turned on or off by a sixth gate signal G_{Ncomk2}. A source electrode of the sixth transistor T6 may be connected to the VEE_{COM} voltage line, and a drain electrode of the sixth transistor To may be connected to the fifth transistor T5 and the LC resonant circuit 1940.

In a transmission mode or haptic mode of the piezoelectric module 1900, a first voltage may be applied to the first unit electrode 1910 and the second voltage may be applied to the second electrode layer 1930, according to the on/off of the plurality of transistors T1, T2, T3, T4, T5, and T6. The piezoelectric layer 1920 positioned between the first unit electrode 1910 and the second electrode layer 1930 may contract or expand based on a difference value Vₙₘ between the first voltage and the second voltage. The piezoelectric module 1900 may vibrate by repeating contraction and expansion of the piezoelectric layer 1920 by periodically changing the first voltage applied to the first unit electrode 1910 and the second voltage applied to the second electrode layer 1930.

In a reception mode of the piezoelectric module 1900, the first transistor T1 and the second transistor T2 may be turned off, and the switch SW may be turned on (closed). As the switch SW is turned on, a reception mode control signal RXₙₘ may be applied to the first unit electrode 1910.

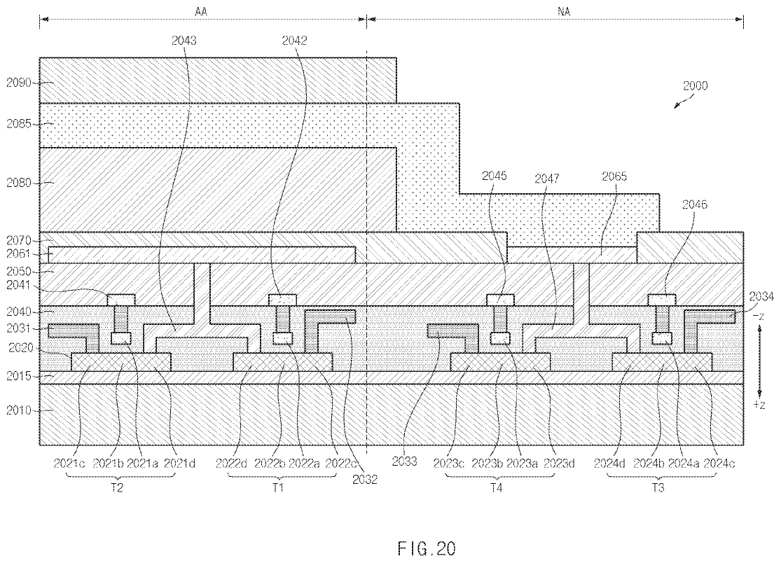

FIG. 20 is a cross-sectional view of a piezoelectric module 2000 of an electronic device according to an embodiment. The piezoelectric module 2000 may include an inactive region NA and an active region AA (e.g., the first region A1 or the second region A2) that detects biometric information or provides haptic feedback.

The piezoelectric module 2000 may include a substrate 2010, a buffer layer 2015, a first transistor T1, a second transistor T2, a third transistor T3, a fourth transistor T4, a plurality of signal lines, an insulating layer 2040, a planarization layer 2050, the first unit electrode 2061 (or the second unit electrode), a protective layer 2070, a piezoelectric layer 2080, a second electrode layer 2085, and a reflective layer 2090.

The substrate 2010 may include a flexible material.

The buffer layer 2015 may be positioned on the substrate 2010, The buffer layer 2015 may improve characteristics of polycrystalline silicon by intercepting impurities from the substrate 2010 during a crystallization process for forming polycrystalline silicon, and may planarize the substrate 2010 to relieve stress of a semiconductor 2020 positioned on the buffer layer 2015.

The semiconductor 2020 may include a channel doped with N-type impurities or P-type impurities and source and drain electrodes positioned on both sides of the channel and having a higher doping concentration than the channel doped with doping impurities. The semiconductor 2020 may be made of polysilicon or oxide semiconductor.

The first transistor T1 may be positioned in the active region AA. The first transistor T1 may include a first gate electrode 2022a, a first channel 2022b, a first source electrode 2022c, and a first drain electrode 2022d. The first gate electrode 2022a may overlap the first channel 2022b. The first gate electrode 2022a may be connected to the first gate line 2042. The first source electrode 2022c may be connected to a VDD voltage line 2032. The first drain electrode 2022d may be connected to the first unit electrode 2061 (or the second unit electrode) through a first connecting member 2043.

The second transistor T2 may be positioned in the active region AA. The second transistor T2 may include a second gate electrode 2021a, a second channel 2021b, a second source electrode 2021c, and a second drain electrode 2021d. The second gate electrode 2021a may overlap the second channel 2021b. The second gate electrode 2021a may be connected to a second gate line 2041. The second source electrode 2021c may be connected to a VEE voltage line 2031. The second drain electrode 2021d may be connected to the first unit electrode 2061 (or the second unit electrode) through the first connecting member 2043.

The third transistor T3 may be positioned in the inactive region NA. The third transistor T3 may include a third gate electrode 2024a, a third channel 2024b, a third source electrode 2024c, and a third drain electrode 2024d. The third gate electrode 2024a may overlap the third channel 2024b. The third gate electrode 2024a may be connected to a third gate line 2046. The third source electrode 2024c may be connected to a VDD_{COM} voltage line 2034. The third drain electrode 2024d may be connected to the second electrode layer 2085 through a second connecting member 2047 and a third connecting member 2065.

The fourth transistor T4 may be positioned in the inactive region NA. The fourth transistor T4 may include a fourth gate electrode 2023a, a fourth channel 2023b, fourth source electrode 2023c, and a fourth drain electrode 2023d. The fourth gate electrode 2023a may overlap the fourth channel 2023b. The fourth gate electrode 2023a may be connected to a fourth gate line 2045. The fourth source electrode 2023c may be connected to a VEE_{COM} voltage line 2033. The fourth drain electrode 2023d may be connected to the second electrode layer 2085 through the second connecting member 2047 and the third connecting member 2065.

The insulating layer 2040 may be positioned between the plurality of conductive pattern layers.

The planarization layer 2050 may be positioned on the insulating layer 2040. The planarization layer 2050 may planarize upper surfaces of the conductive patterns and the insulating layer 2040.

The first unit electrode 2061 (or the second unit electrode) may be positioned on the planarization layer 2050.

The protective layer 2070 may cover the first unit electrode 2061 to protect the first unit electrode 2061.

The piezoelectric layer 2080, the second electrode layer 2085, and the reflective layer 2090 (e.g., the hack layer 1070 of FIG. 10) may be sequentially stacked on the protective layer 2070. The second electrode layer 2085 may extend to the inactive region NA, and in the inactive area NA, may be connected to the third transistor T3 and the fourth transistor T4 through the second connecting member 2047 and the third connecting member 2065.

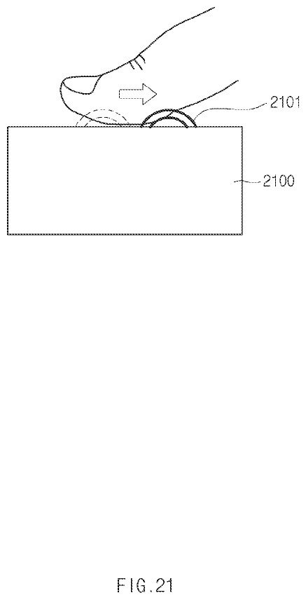

FIG. 21 is a diagram illustrating an electronic device 2100 for providing haptic feedback according to an embodiment. Hereinafter, an operation of an electronic device (e.g., the electronic device 101 of FIG. 1 or the electronic device 200 of FIG. 2) may be referred to as an operation of a processor (e.g., the processor 120 of FIG. 1).

Referring to FIG. 21, the electronic device 2100 according to an embodiment may form an irregularity 2101 (or vibration) on at least one portion of the electronic device 2100 through a piezoelectric module, so that the electronic device 2100 interacts with a user using a user's tactile sensation. The electronic device 2100 according to an embodiment may control the piezoelectric module so that the position of the irregularity 2101 moves in one direction. For example, the piezoelectric module of the electronic device 2100 may move the position of the irregularity 2101 in one direction to guide a user input position, or indicate a type of user interface (e.g., a volume up icon) to the user through touch.

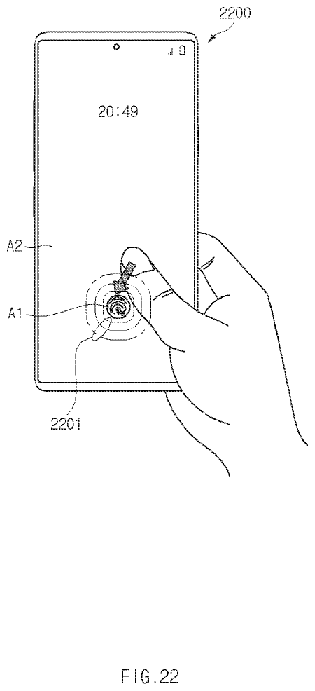

FIG. 22 is a diagram illustrating an electronic device 2200 for providing haptic feedback according to an embodiment. Referring to FIG. 22, the electronic device 2200 (e.g., the electronic device 101 of FIG. 1 or the electronic device 200 of FIG. 2) according to an embodiment may include a first region A1 for detecting biometric information and a second region A2 for providing haptic feedback. The electronic device 2200 may generate an irregularity 2201 (or vibration) in at least one portion of the second region A2. The electronic device 2200 may control a piezoelectric module so that the irregularity 2201 moves in a direction from the periphery of the first region A1 toward the first region A1, in the second region A2. Accordingly, the electronic device 2200 may guide a user's finger to be positioned in the first region A1 where biometric information is detected.

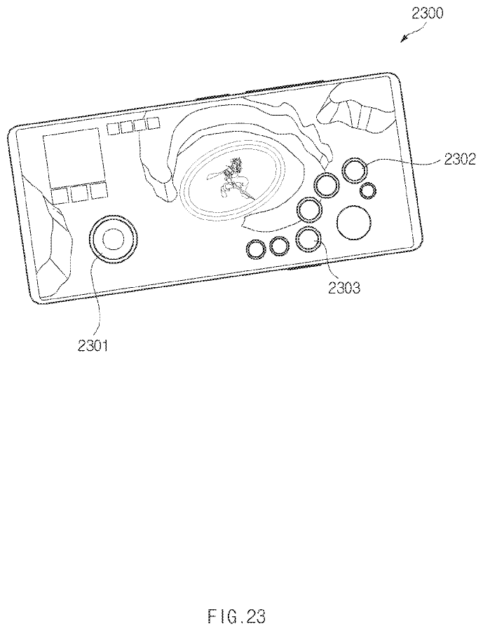

FIG. 23 is a diagram illustrating an electronic device 2300 for providing haptic feedback according to an embodiment. The electronic device 2300 (e.g., the electronic device 101 of FIG. 1 or the electronic device 200 of FIG. 2) according to an embodiment may display a plurality of icons 2301, 2302, and 2303 through a display. The electronic device 2300 according to an embodiment may provide haptic feedback using an irregularity or vibration to a position corresponding to each of the plurality of icons 2301, 2302, and 2303. The electronic device 2300 may provide different haptic feedback types to each of the plurality of icons 2301, 2302, and 2303. For example, different intensities of irregularity or vibration may be applied or a different moving direction of irregularity may be controlled, to each of the plurality of icons 2301, 2302, and 2303.

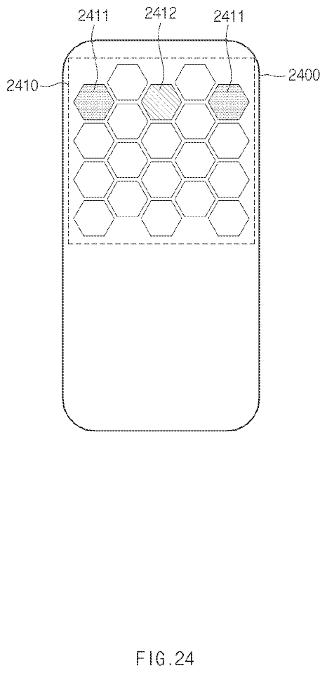

Hereinafter, an electronic device 2400 according to an embodiment will be described with reference to FIG. 24. FIG. 24 is a diagram illustrating the electronic device 2400 according to an embodiment.

The electronic device 2400 (e.g., the electronic device 101 of FIG. 1 or the electronic device 200 of FIG. 2) according to an embodiment may include a piezoelectric module 2410. The piezoelectric module 2410 may include a first electrode layer including a plurality of electrodes. At least one of the plurality of electrodes of the first electrode layer may include a transmission electrode 2411, and at least one of the remaining electrodes may include a reception electrode 2412. Based on a voltage applied to the transmission electrode 2411 of the piezoelectric module 2410, at least one region of a piezoelectric layer closer to the transmission electrode 2411 may vibrate in a third frequency band (e.g., 20 KHz to 100 KHz) to emit ultrasonic waves. For example, the third frequency band may be higher than the audible frequency band and lower than the first frequency band of ultrasonic waves emitted for biometric information detection. The reception electrode 2412 of the piezoelectric module 2410 may detect ultrasonic waves reflected by an external object. The piezoelectric module 2410 may detect proximity of the external object through detected ultrasonic waves. According to an embodiment, the piezoelectric module 2410 may generate sound waves in the audible frequency band or output a specified sound.

An electronic device according to an embodiment may include a housing (e.g., the housing 210 of FIG. 2) and a piezoelectric module (e.g., the piezoelectric module 235 of FIG. 4) positioned in the housing and including a first region for detecting biometric information using ultrasonic waves and a second region for providing haptic feedback, the piezoelectric module may include a first electrode layer (e.g., the first electrode layer 520) and a second electrode layer (e.g., the second electrode layer 540 of FIG. 5) facing each other and a piezoelectric layer (e.g., the piezoelectric layer 530 of FIG. 5) positioned between the first electrode layer and the second electrode layer and including a piezoelectric material, at least one region of the piezoelectric layer positioned in the first region (e.g., the first region A1) of the piezoelectric module may vibrate in a first frequency band to emit the ultrasonic waves, and at least one region of the piezoelectric layer positioned in the second region (e.g., the second region A2) of the piezoelectric module may vibrate in a second frequency band lower than the first frequency hand.

In an embodiment, the first electrode layer may include a first unit electrode (e.g., the first unit electrode 521 of FIG. 5) positioned in the first region and a second unit electrode (e.g., the second unit electrode 522 of FIG. 5) positioned in the second region, and a width of the first unit electrode may be smaller than a width of the second unit electrode.

In an embodiment, the second electrode layer may include a first counter electrode (e.g., the first counter electrode 541 of FIG. 5) positioned in the first region and facing the first unit electrode and a second counter electrode (e.g., the second counter electrode 542 of FIG. 5) positioned in the second region and facing the second unit electrode.

In an embodiment, the second unit electrode and the second counter electrode may have a hexagonal shape.

In an embodiment, the second unit electrode may include at least one hole positioned along an outer edge.

In an embodiment, the second counter electrode may include a plurality of body parts (e.g., the body parts 1611 of FIG. 16) and connecting parts (e.g., the connecting parts 1612 of FIG. 16) connecting the plurality of body parts.

In an embodiment, the piezoelectric module may further include a flexible substrate (e.g., the substrate 510 of FIG. 5).

In an embodiment, the electronic device may further include a back layer (e.g., the back layer 1070 of FIG. 10) positioned on one side of the piezoelectric module and reflecting ultrasonic waves emitted from the piezoelectric module.

In an embodiment, the back layer (e.g., the back layer 1370 of FIG. 13) may include a plurality of holes (e.g., the plurality of holes 1371 of FIG. 13) in the second region.

The electronic device according to an embodiment may further include a display (e.g., the display 710 of FIG. 7), and the piezoelectric module may be positioned on a back surface of the display.

The electronic device according to an embodiment may further include a barrier layer (e.g., the barrier layer 1040 of FIG. 10) positioned between the display and the piezoelectric module.

The electronic device according to an embodiment may further include a bending region that is foldable or unfoldable, the piezoelectric layer may include a first piezoelectric layer (e.g., the first piezoelectric layer 1463a of FIG. 14) and a second piezoelectric layer (e.g., the second piezoelectric layer 1463b of FIG. 14) positioned on both sides of the bending region, and the first piezoelectric layer and the second piezoelectric layer may be spaced apart.

In an embodiment, the piezoelectric module may include at least one transistor connected to the second electrode layer and a first voltage line.

In an embodiment, the piezoelectric module may further include an inactive region positioned outside the first region and the second region, the second electrode layer may extend from the first region or the second region to the inactive region, and in the inactive region, the second unit electrode may be connected to the at least one transistor.

In an embodiment, the first electrode layer may include at least one transmission electrode and at least one reception electrode, and the piezoelectric module may emit ultrasonic waves based on a voltage applied to the transmission electrode, and detect proximity of an external object by detecting ultrasonic waves reflected by the external object through the reception electrode.

An electronic device according to an embodiment may include a housing (e.g., the housing 210 of FIG. 2), a display (e.g., the display 710 of FIG. 7) positioned in the housing, and a piezoelectric module (e.g., the piezoelectric module 235 of FIG. 4) including a first region positioned on a back surface of the display and detecting biometric information using ultrasonic waves and a second region providing haptic feedback, the piezoelectric module may include a first electrode layer (e.g., the first electrode layer 520 of FIG. 5) including a plurality of first unit electrodes (e.g., the first unit electrodes 521 of FIG. 5) positioned in the first region and a plurality of second unit electrodes (e.g., the second unit electrodes 522 of FIG. 5) positioned in the second region, a second electrode layer (e.g., the second electrode layer 540 of FIG. 5) facing the first electrode layer, and a piezoelectric layer (e.g., the piezoelectric layer 530 of FIG. 5) positioned between the first electrode layer and the second electrode layer, and an area of the first unit electrode may be smaller than an area of the second unit electrode.

In an embodiment, the second electrode layer may include a first counter electrode (e.g., the first counter electrode 541 of FIG. 5) positioned in the first region and facing the first unit electrode and a second counter electrode (e.g., the second counter electrode 542 of FIG. 5) positioned in the second region and facing the second unit electrode.

In an embodiment, the piezoelectric module may be configured to form an irregularity in one region of the second region based on a difference between voltages applied to at least one of the plurality of second unit electrodes and the second electrode layer, and move a position of the irregularity in the second region.

In an embodiment, the piezoelectric module may be configured to move a position of the irregularity in a direction that is toward the first region in the second region.

In an embodiment, the display may be configured to display a first icon and a second icon, and the piezoelectric module may be configured to generate different intensities of vibration at a position corresponding to the first icon and a position corresponding to the second icon.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added.

Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a housing; and
a piezoelectric module positioned in the housing and including a first region for detecting biometric information using ultrasonic waves and a second region for providing haptic feedback,
wherein the piezoelectric module includes:
a first electrode layer and a second electrode layer facing each other; and
a piezoelectric layer positioned between the first electrode layer and the second electrode layer,
wherein at least a portion of the piezoelectric layer positioned in the first region of the piezoelectric module vibrates in a first frequency band to emit the ultrasonic waves, and
wherein at least a portion of the piezoelectric layer positioned in the second region of the piezoelectric module vibrates in a second frequency band lower than the first frequency band.

2. The electronic device of claim 1, wherein the first electrode layer includes a first unit electrode positioned in the first region and a second unit electrode positioned in the second region, and
a width of the first unit electrode is smaller than a width of the second unit electrode.

3. The electronic device of claim 2, wherein the second electrode layer includes a first counter electrode positioned in the first region and facing the first unit electrode and a second counter electrode positioned in the second region and facing the second unit electrode.

4. The electronic device of claim 3, wherein the second unit electrode and the second counter electrode have a hexagonal shape.

5. The electronic device of claim 4, wherein the second unit electrode includes at least one hole positioned along an outer edge of the second unit electrode.

6. The electronic device of claim 3, wherein the second counter electrode includes a plurality of body parts and connecting parts connecting the plurality of body parts.

7. The electronic device of claim 2, wherein the piezoelectric module further includes a flexible substrate.

8. The electronic device of claim 2, further comprising a back layer positioned on one side of the piezoelectric module and reflecting ultrasonic waves emitted from the piezoelectric module.

9. The electronic device of claim 8, wherein the back layer includes a plurality of holes in the second region.

10. The electronic device of claim 2, further comprising a display,
wherein the piezoelectric module is positioned on a hack surface of the display.

11. The electronic device of claim 10, further comprising a barrier layer positioned between the display and the piezoelectric module.

12. The electronic device of claim 10, further comprising a bending region that is foldable or unfoldable,
wherein the piezoelectric layer includes a first piezoelectric layer and a second piezoelectric layer positioned on both sides of the bending region, and
the first piezoelectric layer and the second piezoelectric layer are spaced apart.

13. The electronic device of claim 2, wherein the piezoelectric module includes at least one transistor connected to the second electrode layer and a first voltage line.

14. The electronic device of claim 13, wherein the piezoelectric module further includes an inactive region positioned outside the first region and the second region,
the second electrode layer extends from the first region or the second region to the inactive region, and
in the inactive region, the second unit electrode is connected to the at least one transistor.

15. The electronic device of claim 1, wherein the first electrode layer includes at least one transmission electrode and at least one reception electrode, and
the piezoelectric module
emits ultrasonic waves based on a voltage applied to the transmission electrode, and
detects proximity of an external object by detecting ultrasonic waves reflected by the external object through the reception electrode.

16. A method comprising:
forming a piezoelectric module comprising a first region for detecting biometric information using ultrasonic waves and a second region for providing haptic feedback, wherein forming the piezoelectric module comprises:
forming a first electrode layer and a second electrode layer facing each other; and
positioning a piezoelectric layer between the first electrode layer and the second electrode layer,
wherein at least a portion of the piezoelectric layer positioned in the first region of the piezoelectric module vibrates in a first frequency band to emit the ultrasonic waves, and
wherein at least a portion of the piezoelectric layer positioned in the second region of the piezoelectric module vibrates in a second frequency band lower than the first frequency band.
